(19) United States
(12) Patent Application Publication
(10) Pub. No.: US 2024/0092692 A1
(43) Pub. Date: Mar. 21, 2024

(54) RAW MATERIAL FOR PRODUCING CONSTRUCTION MATERIAL, MATERIAL MIXTURE WHICH CAN BE USED AS CONSTRUCTION MATERIAL, CONCRETE MADE OF A MATERIAL MIXTURE, AND METHOD FOR PRODUCING A MATERIAL MIXTURE WHICH CAN BE USED AS CONSTRUCTION MATERIAL

(71) Applicant: TRITON CHEMICALS INTERNATIONAL LTD., Graalum (NO)

(72) Inventor: Gerd THÖNE, Bad Salzufflen (DE)

(21) Appl. No.: 18/264,887

(22) PCT Filed: Feb. 10, 2022
(86) PCT No.: PCT/EP2022/053301

§ 371 Date: Aug. 9, 2023

(30) Foreign Application Priority Data
Feb. 11, 2021 (DE) 10 2021 103 219.9

(51) Int. Cl. C04B 14/06; C04B 22/06; C04B 24/26; C04B 24/38; C04B 24/42; C04B 28/02

(52) U.S. Cl. CPC C04B 14/068; C04B 14/062; C04B 22/064; C04B 24/2641; C04B 24/383; C04B 24/42; C04B 28/02; C04B 2103/32

(57) ABSTRACT

A basic substance for the production of a building material includes at least one additive for influencing the properties and at least one filler which serves as a basic material. The basic substance is characterized in that the at least one additive includes nanoparticles and in that the at least one filler includes desert sand. Also related are a corresponding substance mixture, a corresponding concrete, and a corresponding method for producing a substance mixture which can be used as a building material.

### CROSS-REFERENCE TO RELATED APPLICATIONS

This application is a 35 U.S.C. § 371 National Stage patent application of PCT/EP2022/053301, filed on 10 Feb. 2022, which claims the benefit of German patent application 10 2021 103 219.9, filed on 11 Feb. 2021, the disclosures of which are incorporated herein by reference in their entirety.

### TECHNICAL FIELD

The present disclosure relates to a basic substance for the production of a building material having the features of the preamble of claim 1, a substance mixture usable as a building material having the features of the preamble of claim 11, a concrete having the features of the preamble of claim 15, and a method for producing a substance mixture usable as a building material having the features of the preamble of claim 16.

### BACKGROUND

In the course of increasing industrialisation in many countries of the world and people's ever-increasing need for space, building construction is becoming more and more important. One of the most common building materials is concrete. It is resistant and therefore durable. Concrete is an inexpensive material and the materials needed for a concrete mix—binders such as cement, water and a filler such as sand—are readily available in many parts of the world.

The easy availability of sand, however, does not apply to desert regions in the Arab world, for example, since the desert sand there is not readily suitable for use in concrete. This lack of suitability means that large quantities of suitable sand have to be imported into these desert regions from Australia or Iran, for example, in order to produce concrete there.

The binder, such as cement, sets with a gypsum-generated ettringite formation, so that the resulting needle-shaped crystals create a bond between the filler particles, such as sand grains, and bind them firmly together. Desert sand is usually not suitable for this due to its grain shape and grain size, as its round, almost spherical grains form too many or excessively large gaps in a pour, which can then only be bridged poorly by the binder or cement. This in turn leads to the fact that the hardened concrete with desert sand has excessively low strengths to be considered for building construction.

To improve the properties, it is known from ultra-high-strength concretes that the strengths can be increased by adding quartz powders, such as SiO₂ quartz, of about 10% to the concrete. However, this process is very expensive due to the large amount of additive required and only achieves small strength increases when desert sand is used as a filler.

### SUMMARY

Thus, the disclosure provides a substance mixture which can be used as a building material in building construction, wherein desert sand is used as a filler. The disclosure provides a corresponding basic substance for the production of a building material, a concrete and a method for producing a substance mixture which can be used as a building material.

In relation to a basic substance for the production of a building material having the features of the preamble of claim 1, this is achieved by providing the features of the characterising part of claim 1. In relation to a substance mixture usable as a building material having the features of the preamble of claim 11, this is achieved by providing the features of the characterising part of claim 11. In relation to a concrete having the features of the preamble of claim 15, this is achieved by providing the features of the characterising part of claim 15. In relation to the method for producing a substance mixture usable as a building material having the features of the preamble of claim 16, this is achieved by providing the features of the characterising part of claim 16.

The percentages here and below refer to percentages by weight unless otherwise stated.

The disclosure thus relates to a basic substance for producing a building material comprising at least one additive for influencing the properties and at least one filler which serves as a basic material.

The basic substance according to the disclosure is characterised in that the at least one additive comprises nanoparticles in the form of silicon dioxide, and in that the at least one filler comprises desert sand, the nanoparticles having a particle size less than 10 nm. As an alternative designation for the term “additive”, “aggregate” may also be used. As an alternative designation for the term “filler”, “supplement” may also be used. This “supplement” shall be distinguished from the “aggregate”.

The disclosure further relates to a substance mixture usable as a building material and in particular usable as concrete with water for chemical setting.

The substance mixture according to the disclosure is characterised in that the substance mixture comprises a basic substance according to the disclosure and in that the at least one filler forms the main constituent of the substance mixture.

The disclosure also relates to a concrete formed from a substance mixture. The concrete according to the disclosure is characterised in that the substance mixture is a substance mixture according to the disclosure.

Lastly, the disclosure relates to a method for producing a substance mixture usable as a building material, wherein a binder, water for chemical setting, at least one additive for influencing the properties and at least one filler are mechanically mixed as a basic material, the at least one filler forming the main constituent of the substance mixture.

### DETAILED DESCRIPTION OF THE DISCLOSURE

The method according to the disclosure is characterised in that the at least one additive comprises nanoparticles in the form of silicon dioxide particles, the nanoparticles having a particle size less than 10 nm, and the at least one filler comprises desert sand.

The term “additive” can be understood here as any constituent of the building material that is neither the basic material nor the binder for the building material.

In particular, the at least one additive can serve to influence the properties of the building material. It may be that the basic substance comprises more than one additive and thus additives.

Preferably, the at least one filler serves as a basic material for the building material. In particular, the building material may be concrete. It may be that the basic substance comprises more than one filler and thus fillers. Alternatively, the basic substance may comprise only one filler.

The binder comprises cement. It can consist of cement. Cement is an inorganic substance and is usually finely ground. Due to its properties, it serves as a binder in the substance mixture or in the concrete. It hardens through the chemical reaction with water (hydration) and then remains solid. This process is also called setting. All types of cement common in the construction industry can be used as binders.

The at least one additive may in particular comprise all substances added to the basic substance in order to influence its properties, the properties of the substance mixture or the properties of the building material before, during and after setting. These may be substances to influence the viscosity or flow properties of the basic substance or the substance mixture, or the strength, the shrinkage of the building material or concrete, the water permeability of the building material or concrete, the chemical resistance or similar. The at least one additive may be added here in solid, liquid or possibly gaseous form and may be added directly as a pure substance or in solutions or emulsions.

The main constituent is understood here to be a proportion of at least 50%, preferably of at least 60%, further preferably of at least 70% of the substance mixture. In the present substance mixture, this main constituent is formed by the at least one filler. All fillers together can also form the main constituent. Fillers in general are substances that behave passively, i.e. do not participate in the chemical reaction and do not significantly influence it. They are usually used for cost reasons to replace more expensive constituents of the basic substance or substance mixture. Therefore, all inexpensive substances whose own strength is sufficiently high can be considered. Bulk materials are often used as fillers, and therefore the strength of the individual particles or grains must be high enough. Examples of typical bulk materials as fillers are sand and gravel.

In the present disclosure, desert sand is used as a filler. Desert sand is very suitable as a low-cost filler due to the strength of its grains and its large occurrences in desert areas. However, desert sand does not necessarily have to come from desert areas. Rather, desert sand is characterised by its grain sizes and grain shapes. Such round grains can, for example, be created by winds in the desert, which constantly circulate the sand and thus round off grains over time that were initially angular. Sand with round grains formed in this way is also called windblown sand and is also covered by the term desert sand in this application. The sand grains may also have been rounded by water. Preferably, the desert sand has a proportion of at least 90% and in particular of at least 95% of grains which are substantially round. Substantially round means here and hereinafter substantially spherical.

Another characteristic variable is the grain size. For example, all sands whose grain sizes are fundamentally very small are also to be understood as desert sands. Thus, these desert sands fundamentally comprise fine fractions and only low medium and coarse fractions. Preferably, the desert sand comprises predominantly, i.e. in particular at least 50% or at least 75%, grains with a grain size between 0.05 mm to 0.2 mm. Preferably, grains in the range of about 0.2 mm to 0.6 mm are hardly present and coarse grain sizes in the range of about 0.6 mm to 2 mm are hardly present. Thus, the desert sand may be characterised in that at least 80% of the sand grains have a grain size smaller than 0.20 mm and at most 15% are larger than 0.60 mm. Preferably, at least 90% of the sand grains are smaller than 0.20 mm and at most 10% are larger than 0.60 mm.

Surprisingly, it has been found that the presence of the nanoparticles results in the formation not of the ettringite bonds normally preferably formed by the binder or cement between the filler particles, but primarily of calcium-silicon-hydrate (CSH) bonds. The CSH bonds form a cotton-wool-like structure that is able to fill the voids between spherical desert sand grains while providing the necessary stability. The CSH bonds are also able to fill larger gaps between grains in a better and more stable way. Preferably, therefore, nanoparticles are included which lead to the formation of CSH bonds in the binder or cement. Significantly higher strengths are achieved from such a building material or concrete than from a building material or concrete containing desert sand but without nanoparticles.

A preferred embodiment is characterised in that the fillers comprise at least 50% desert sand. In addition to desert sand, other fillers such as conventional sand with sharp-edged grains or gravel may be used. In order to optimise the strength of the hardened building material or concrete, a proportion of 50% desert sand in the at least one filler may be advantageous. It may also be advantageous to have a desert sand content of at least 60%, at least 70%, at least 80% or at least 90%, depending on the application. It may also be that this preferred proportion of desert sand relates to all fillers as a whole. In this way, it may be possible to make very extensive use of locally available desert sand without having to transport other types of sand in large quantities.

In addition to desert sand, almost any material that is available in the region of the construction site or in the area of use can be used as a filler. Ballast, earth, sand or even broken asphalt are particularly suitable.

Thus, in a further embodiment of the substance mixture according to the disclosure, the latter is characterised in that any type of soil and/or materials such as bauxite, laterite, volcanic ash, pumice, recycled concrete and ash from combustion processes can be used as filler.

According to a further preferred embodiment, it is provided that fillers comprise at least 50% fine sand, preferably at least 80%, further preferably at least 90%. Here and hereinafter, fine sand is understood to mean sand with grain sizes between 0.063 mm to 0.2 mm.

According to a further preferred embodiment, it is provided that the at least one filler comprises a sand having substantially spherical grains. Similarly, it may be that the at least one filler consists of sand having substantially spherical grains. A sand with substantially spherical grains may also comprise grains whose shape is irregular but whose corners and edges are rounded. Proportions of the sand with substantially spherical grains in the at least one filler or in all fillers in total of at least 50%, at least 60%, at least 70%, at least 80% or at least 90% may be advantageous.

According to a further preferred embodiment, it is provided that the at least one filler comprises at least 10% concrete gravel, preferably at least 20%, further preferably at least 30%. It may also be that all fillers in total have this proportion of concrete gravel. Concrete gravel is a bulk material which is frequently used in the construction industry for concrete production and comprises a mixture of sand and gravel in certain grain sizes. Preferably, the concrete gravel has predominantly grain sizes smaller than 16 mm or smaller than 32 mm.

A preferred embodiment is characterised in that the nanoparticles have a quantitative proportion of from 0.005% to 0.2%, preferably from 0.01% to 0.1% of the binder and preferably of the cement. In other words, the weight of the nanoparticles is in the corresponding percentage range of the weight of the binder or the cement. Similarly, it is preferred that the nanoparticles have a proportion of from 0.1% to 2%, preferably from 0.2% to 0.6%, of the at least one additive or of all additives.

According to the disclosure, it is provided that the nanoparticles comprise silicon dioxide particles, preferably consist of silicon dioxide particles. Silicon dioxide in nanoparticle size is a suitable additive which preferably allows the cement to form the mentioned CSH bonds.

According to a further preferred embodiment, it is provided that the nanoparticles comprise polydimethylsiloxane particles or consist of polydimethylsiloxane particles. Polydimethylsiloxane is also suitable for allowing the cement to form the CSH bonds.

Similarly, the nanoparticles may comprise both polydimethylsiloxane particles and silicon dioxide particles.

According to a further preferred embodiment, it is provided that the nanoparticles were present in an aqueous emulsion and are or were supplied in this state to the basic substance or the substance mixture. For a more homogeneous distribution and to avoid the formation of lumps, it is advantageous if the nanoparticles are first processed with water to form an emulsion, which is then added in this form to the basic substance or the substance mixture.

According to the disclosure, it is provided that the nanoparticles have a particle size of less than 10 nm. Preferably, the nanoparticles have a particle size substantially entirely smaller than 10 nm.

A preferred embodiment is characterised in that the basic substance has additives in the proportions shown:
10% to 20%, preferably 16.5% superplasticiser with polycarboxylate and/or 5% to 15%, preferably 8.3% organosilanol and/or
30% to 60%, preferably 45.2% water, and/or 1% to 3%, preferably 2.2%, of at least one of hydroxyethyl cellulose and carboxymethyl cellulose, and/or
0.01% to 0.6%, preferably 0.3% hydrated lime or slaked lime, and/or
5% to 20%, preferably 12.4% setting accelerator and/or
5% to 20%, preferably 13.7% latex powder or latex dispersion and/or
0.1% to 2%, preferably 0.8% preservative.

It is further preferred that the proportions of the constituents of the additives just mentioned together with the proportion of nanoparticles add up to 100 percent.

Preferably, the setting accelerator comprises calcium formate or consists of calcium formate.

Compared to the preferred embodiment just described, it is also possible to significantly increase the water content of the additives, for example to 80-90%, but keeping the ratios of the other additives substantially the same.

A corresponding preferred embodiment is characterised in that the basic substance has additives in the proportions stated:
less than 10%, preferably 6% superplasticizer with polycarboxylate and/or
1% to 5%, preferably 3% organosilanol and/or
60% to 90%, preferably 80.1% water, and/or
0.5% to 1.5%, preferably 0.8%, of at least one of hydroxyethyl cellulose and carboxymethyl cellulose, and/or
0.01% to 0.5%, preferably 0.1% hydrated lime or slaked lime, and/or
2.5% to 6.5%, preferably 4.5% setting accelerator and/or
3% to 7%, preferably 5% latex powder or latex dispersion and/or
0.1% to 0.5%, preferably 0.3% preservative.

It is further preferred that the proportions of the constituents of the additives just mentioned together with the proportion of nanoparticles add up to 100 percent.

According to a preferred embodiment of the substance mixture according to the disclosure, it is provided that the substance mixture comprises the at least one additive with a proportion by weight of from 1% to 10%, preferably from 2% to 3%, of the proportion by weight of the binder. It is also possible that all additives together have the above weight proportion. The ratio of additives and binder—e.g. cement—plays a decisive role in the formation of the CSH bonds in the substance mixture. Therefore, it is advantageous if the quantity of the added additives is adjusted to the quantity of the cement. Additive quantities of 1% to 15%, in particular 2% to 10%, have proven to be advantageous for the mechanical properties. However, depending on the application, 2% to 3% can also be advantageous. As already mentioned, these percentages are related to the weight of the binder and in particular to the weight of the cement.

According to a further preferred embodiment of the substance mixture according to the disclosure, it is provided that the cured substance mixture is suitable for building construction. The cured mixture may also be referred to as a building material or concrete. Suitable for building construction primarily means that the strengths of the cured building material or concrete from the substance mixture according to the disclosure are comparable to or better than the strengths of conventional building material or concrete for building construction. Preferably, the cured substance mixture has a compressive strength of at least 30 N/mm², more preferably at least 35 N/mm².

It is preferred that the hardened substance mixture has a flexural strength of at least 1.5 N/mm². It is also preferred that the hardened mixture has a modulus of elasticity of at least 30 N/mm².

The water permeability of the hardened substance mixture—building material or concrete—also plays a major role. If this is too high, substances can be washed out of the building material or concrete and thus subsequently reduce its strength. Therefore, the hardened substance mixture preferably has a water permeability of less than 0.01%.

A preferred embodiment of the method according to the disclosure is characterised in that the silicon oxide is added to the substance mixture in the form of an aqueous emulsion.

Preferred embodiments, features and properties of the basic substance according to the disclosure, the substance mixture according to the disclosure, the concrete according to the disclosure or the method according to the disclosure correspond to those of the other subjects according to the disclosure, and vice versa.

In a first exemplary embodiment, additives comprising the following constituents are mixed together:
0.6% nanoparticles of silicon dioxide with a particle size smaller than 10 nm,
16.5% superplasticizer with polycarboxylate,
8.3% organosilanol,
45.2% water,
2.2% hydroxyethyl cellulose,
0.3% slaked lime,
12.4% setting accelerator,
13.7% latex powder and
0.8% preservative.

10 kilograms of these additives are mixed with 400 kilograms of cement as well as water and desert sand as filler and then form a concrete with a total weight of 2000 kilograms.

In a second exemplary embodiment, additives comprising the following constituents are mixed together:
0.2% nanoparticles of polydimethylsiloxane with a particle size smaller than 10 nm,
6% superplasticizer with polycarboxylate,
3% organosilanol,
80.1% water,
0.8% hydroxyethyl cellulose,
0.1% slaked lime,
4.5% setting accelerator,
5% latex powder and
0.3% preservative.

60 kilograms of these additives are mixed with 600 kilograms of cement and water and desert sand as filler to then form a concrete. This has a total weight of 2000 kilograms.

1. A basic substance for the production of a building material, the basis substance comprising: a binder which comprises cement, at least one additive for influencing the properties and at least one filler which serves as a basic material, wherein the at least one additive comprises nanoparticles in the form of silicon dioxide particles, the nanoparticles having a particle size less than 10 nm, and in that the at least one filler comprises desert sand.

2. The basic substance according to claim 1, wherein the at least one filler comprises at least 50% desert sand.

3. (canceled)

4. (canceled)

5. (canceled)

6. The basic substance according to claim 1, wherein the nanoparticles consist of silicon dioxide particles.

7. The basic substance according to claim 1, wherein the nanoparticles comprise polydimethylsiloxane particles.

8. The basic substance according to claim 1, wherein the nanoparticles were present in an aqueous emulsion and were supplied to the basic substance in this state.

9. (canceled)

10. The basic substance according to claim 1, wherein the basic substance comprises additives in the stated proportions:
less than 10% superplasticiser with polycarboxylate and/or
1.0 to 5.0% organosilanol and/or
60 to 90% water, and/or
0.5 to 1.5% of at least one of hydroxyethyl cellulose and carboxymethyl cellulose, and/or
0.01 to 0.5% hydrated lime or slaked lime, and/or
2.5 to 6.5% setting accelerator and/or
3.0 to 7.0% latex powder or latex dispersion and/or
0.1 to 0.5% preservative.

11. A substance mixture usable as a building material, the substance mixture comprising water for chemical setting, wherein the substance mixture comprises a basic substance according to claim 1 and in that the at least one filler forms the main constituent of the substance mixture.

12. The substance mixture according to claim 11, wherein the substance mixture comprises the at least one additive with a proportion by weight of from 1% to 10% of the proportion by weight of the binder.

13. The substance mixture according to claim 12, wherein the cured substance mixture is suitable for building construction, wherein the cured substance mixture has a compressive strength of at least 30 N/mm².

14. The substance mixture according to claim 13, wherein the nanoparticles have a quantitative proportion of 0.005% to 0.2% of the binder.

15. A concrete formed from a substance mixture, wherein the substance mixture is a substance mixture according to claim 11.

16. A method for producing a substance mixture usable as a building material, wherein a binder, water for chemical setting, at least one additive for influencing the properties and at least one filler as a basic material are mechanically mixed, wherein the at least one filler forms the main constituent of the substance mixture, wherein the at least one additive comprises nanoparticles in the form of silicon dioxide particles, the nanoparticles having a particle size of less than 10 nm, and the at least one filler comprises desert sand.

17. The method according to claim 16, wherein the nanoparticles are added to the substance mixture in the form of an aqueous emulsion.
